(19) United States
(12) Patent Application Publication
(10) Pub. No.: US 2010/0281371 A1
(43) Pub. Date: Nov. 4, 2010

(54) Navigation Tool for Video Presentations

(76) Inventors: Peter Warner, Paris (FR); Douglas DeVore, Campbell, CA (US); Wendy Van Wazer, Campbell, CA (US); Lisa Diener, San Jose, CA (US); Charles Lyons, San Francisco, CA (US)

Correspondence Address: ADELI & TOLLEN, LLP, 11940 San Vicente Blvd., Suite 100, LOS ANGELES, CA, 90049, US

(21) Appl. No.: 12/433,875

(22) Filed: Apr. 30, 2009

(51) Int. Cl. G06F 3/01

(52) U.S. Cl. 715/720; 715/784; 715/786; 715/723

(57) ABSTRACT

Some embodiments provide a method that provides a first display area for displaying a video presentation. The video presentation includes several video clips, each of which includes a particular sequence of consecutive video pictures. The method provides a navigation tool for navigating the video presentation. The navigation tool includes a display of a representative video picture from each video clip in the video presentation. The entire navigation tool is for display at one time in a second display area. In some embodiments the representative video picture for a particular video clip is the first video picture, a particular number of video pictures from the start of the video clip, etc. Some embodiments also provide a third display area for displaying thumbnail images representing a subset of the video clips in the video presentation.

### FIELD OF THE INVENTION

The invention is directed towards media editing and viewing application. Specifically, the invention is directed towards a navigation tool for such applications.

### BACKGROUND OF THE INVENTION

Video editing applications provide film producers, amateur users, etc. with tools to create video presentations (e.g., films). These applications give users the ability to edit, combine, transition, overlay, and piece together different video clips (along with other media content, such as audio) in a variety of ways to create a video presentation. As such, a video presentation is generally composed of a number video clips. In general, a video clip is a single, unbroken video that is imported individually into the video editing application used to create the video presentation.

Once created by compositing the various video clips, video presentations can be both edited and viewed. Post-composition editing can include modifying the color properties of the video clips (i.e., color correction), adding special effects to the video clips, etc. After the video presentation is finalized, it can be distributed in various forms for viewing (e.g., as an electronic file, as a DVD or Blu-Ray disc, etc.).

Both in the post-composition editing stage and the viewing stage, users will want to navigate the video presentation in order to easily jump to a particular point in the presentation. In editing, a user might want to color correct a particular video clip and would need a way to navigate through the potential hundreds, if not thousands, of video clips that make up the presentation. Precisely finding and accessing a particular video clip can be difficult.

Similarly, users watching a video will often want to jump to a particular scene. For navigating a video while viewing it on a digital media player, current players generally only provide a track in the time dimension with a playhead that can be moved in order to jump to a point in the video presentation. However, the typical track just shows a user the time, so in order to reposition the playhead the user is required to guess at the time in the video presentation at which their desired content appears. Attempting to find a particular scene or video clip in this manner can be a tedious process.

DVD players generally provide a scenes menu that has the movie or other video content broken down into scenes (often on the order of a few dozen scenes). A user can access the scenes menu, where each scene is often represented by an image. For the typical DVD, approximately four such images are shown at one time, and a user can jump through the groups of four to find the scene they desire. However, scenes can be on the order of four or five minutes long, and any more precise navigation within a scene must be done with the standard fast-forward and rewind functions. For all of the above applications, tools for more robust navigation of video presentations are needed.

### SUMMARY OF THE INVENTION

For a composite video presentation formed by an ordered series of video clips, some embodiments of the invention provide a novel navigation tool for representing the video clips and navigating through them. Some embodiments select a representative video picture from each video clip in the video presentation and use the representative video pictures to generate the navigation tool.

In some embodiments, exactly one representative video picture from each clip (e.g., a video picture based on location within the clip, a video picture based on analysis of the clip, etc.) is selected for the navigation tool. The selected video pictures are then arranged in a user interface to generate the navigation tool. In some embodiments, the navigation tool is a rectangular display area (e.g., a scrollbar) and the selected video pictures are ordered in the display area to match the order within the video presentation of the video clips they represent.

Different embodiments use the navigation tool to navigate through the video presentation differently. For instance, the selection of a particular video picture in the navigation tool in some embodiments causes the display of the video presentation in a separate display area (for viewing, editing, etc.), starting from the video clip represented by the selected video picture. In such cases, each representative video picture acts as a user interface tool that links to a particular point in the video presentation.

Instead of navigating through the video presentation directly, other embodiments use the navigation tool to navigate through a larger set of representations of the video clips in the video presentation. In order to do this, some embodiments display the navigation tool as a scrollbar in a first display area, while in a second display area display a set of thumbnail images (in some cases, the same images as in the scrollbar) for a user to scroll through. In some embodiments, the first display area has a defined size in which all of the selected representative video pictures are displayed at once. Accordingly, the selected video pictures are compressed in size so as to fit in the first display area. In some cases, the video pictures are compressed to the point that the content is no longer discernible by a human eye. However, the navigation tool will still illustrate the prominent colors of the clips, from which a human can discern the color rhythm of the video project (i.e., sections that are “warm” (light colors) or “cool” (dark colors)). The video pictures in the second display area are displayed in a size large enough that the content is discernible by a human (e.g, as thumbnails).

Some embodiments display a window over the navigation tool to indicate which video clips have video pictures presently displayed in the second display area. This window can be dragged along the navigation tool by the user in order to scroll through the video clips in the second display area. In some embodiments, a user can select a particular video clip for display in a separate display area either using the navigation tool (as described above) or by selecting one of the larger video pictures in the second display area.

The navigation tool as described can be used in a variety of different applications. For instance, the navigation tool of some embodiments is provided in a video-editing application. A user can use the navigation tool to select a video clip for editing (either by selecting directly from the navigation tool or by scrolling through video clips in a second display area). Once the video clip is selected, a user can use editing tools to edit various aspects of the selected clip (e.g., color correction, adding special effects, etc.).

In addition to use in editing applications, the navigation tool can be used in applications for playing a completed composite video presentation. For instance, navigation tools that include one representative video picture per video clip may be used in a DVD player application. In such applications, the video clips are defined as in the editing process in some cases, while in other cases the video clips are defined based on the scenes of the DVD. A viewer of the DVD can use the navigation tool to navigate to a particular scene in the movie (or other video content) that is stored on the DVD.

Similarly, the navigation tool may be provided in applications that play video files other than from DVDs (e.g., personal computer applications such as Quicktime®, applications on handheld devices such as cell phones or media players, etc.) or as the interface for interacting with machines designed specifically for playing DVDs, Blu-Ray® discs, etc. Finally, the navigation tool can be used to navigate through images rather than video. For instance, if a digital photo album groups photos into “events” or “film rolls” (sets of images that are logically grouped together), then one image from each of several sets could be selected and used to generate the navigation tool of some embodiments.

### BRIEF DESCRIPTION OF THE DRAWINGS

The novel features of the invention are set forth in the appended claims. However, for purpose of explanation, several embodiments of the invention are set forth in the following figures.

FIG. 1 conceptually illustrates a video presentation of and a navigation tool generated by selecting a representative frame from each of the video clips in the video presentation according to some embodiments.

FIG. 2 conceptually illustrates a process of some embodiments for generating a navigation tool for a video presentation.

FIG. 3 conceptually illustrates a portion of a video project that is composed of a set of clips.

FIG. 4 conceptually illustrates a process of some embodiments for generating a navigation tool from a set of images.

FIGS. 5 and 6 illustrate examples of navigation tools of some embodiments.

FIG. 7 conceptually illustrates a process of some embodiments for navigating a video presentation with a navigation tool.

FIG. 8 illustrates navigation with the navigation tool of FIG. 5.

FIG. 9 illustrates navigation with the navigation tool of FIG. 6.

FIG. 10 illustrates the navigation tool of FIG. 5 with a window that only covers one image.

FIG. 11 illustrates the navigation tool of FIG. 6 with a window that only covers one image.

FIG. 12 illustrates a navigation tool, a series of larger scrolling images, and a separate display area.

FIG. 13 illustrates the result of a user selecting an image from the series of scrolling images for display in the separate display area.

FIGS. 14-16 illustrate the use of a video-editing application that incorporates the navigation tool of some embodiments.

FIGS. 17-18 illustrate the use of a media player application that incorporates the navigation tool of some embodiments.

FIG. 19 conceptually illustrates the software architecture of a media-editing application of some embodiments for editing images and/or videos.

FIG. 20 conceptually illustrates a process of some embodiments for manufacturing a computer readable medium that stores a computer program.

FIG. 21 conceptually illustrates a computer system with which some embodiments of the invention are implemented.

### DETAILED DESCRIPTION OF THE INVENTION

In the following description, numerous details are set forth for purpose of explanation. However, one of ordinary skill in the art will realize that the invention may be practiced without the use of these specific details. For instance, some portions of the application refer to examples of video clips that are composed of a number of frames. One of ordinary skill will recognize that video clips could be composed of fields or other units of digital video as well.

For a composite video presentation formed by an ordered series of video clips, some embodiments of the invention provide a novel navigation tool for representing the video clips and navigating through them. Some embodiments select a representative video picture from each video clip in the video presentation and use the representative video pictures to generate the navigation tool.

As stated, the video presentation is composed of an ordered series of video clips. Each video clip, in some embodiments, is a series of consecutive ordered video pictures (e.g., frames or fields of video). In some embodiments, a video clip is defined as a series of ordered video pictures that is individually imported into the video presentation.

In some embodiments, exactly one representative video picture from each clip (e.g., a video picture based on location within the clip, a video picture based on analysis of the clip, etc.) is selected for the navigation tool. The selected video pictures are then arranged in a user interface to generate the navigation tool. In some embodiments, the navigation tool is a rectangular display area (e.g., a scrollbar) and the selected video pictures are ordered in the display area to match the order within the video presentation of the video clips they represent.

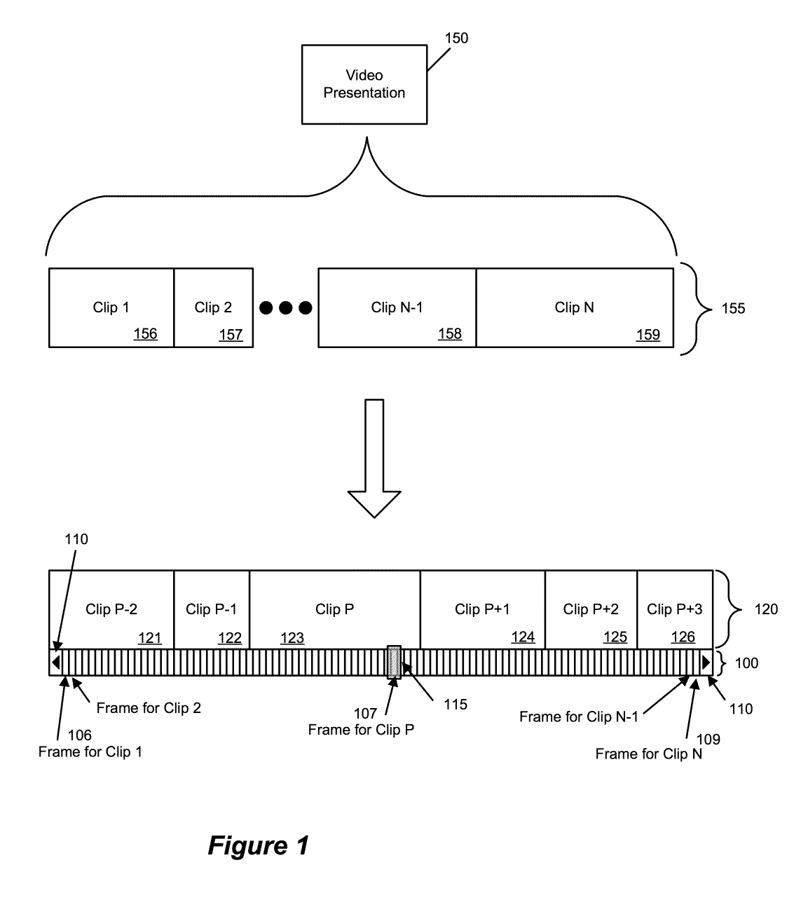

FIG. 1 conceptually illustrates a video presentation 150 that is composed of video clips 155 and a navigation tool 100 generated by selecting a representative frame from each of the video clips 105 according to some embodiments. Navigation tool 100 includes N frames (one for each of the N clips 155) compressed into the display area for the tool 100. The compressed frames are ordered starting from the representative frame 106 for Clip 1 (156) all the way to the representative frame 109 for Clip N (159).

Different embodiments use the navigation tool to navigate through the video presentation differently. For instance, the selection of a particular video picture in the navigation tool in some embodiments causes the display of the video presentation in a separate display area (for viewing, editing, etc.), starting from the video clip represented by the selected video picture. In such cases, each representative video picture acts as a user interface tool that links to a particular point in the video presentation.

Instead of navigating through the video presentation directly, other embodiments use the navigation tool to navigate through a larger set of representations of the video clips in the video presentation. In order to do this, some embodiments display the navigation tool as a scrollbar in a first display area, while in a second display area display a set of thumbnail images (in some cases, the same images as in the scrollbar) for a user to scroll through. This is the case in FIG. 1. The navigation tool 100 includes scroll arrows 110 and a scroll window (i.e., thumb, elevator, etc.) 115 as well as the representative frames. Above the navigation tool 100 are frames 120 for a subset of the N video clips 155 in video presentation 150. In some embodiments, a user can scroll through the frames 120 using the navigation tool 100. For instance, a user can drag scroll window 115, select scroll arrows 110, or click directly on one of the representative frames in navigation tool 100.

As shown in FIG. 1, the scroll window 115 is currently over the representative frame 107 for Clip P. As such, Clip P is currently at the center (or close to the center) of the second display area. In some embodiments, the scroll window is larger than that shown in FIG. 1, and resides over all of the representative frames that correspond to the frames displayed in the second display area (i.e., in the example of FIG. 1, such a scroll window would cover six of the representative frames corresponding to Clip P−2 though Clip P+3).

In some embodiments, as shown in FIG. 1, the first display area has a defined size in which all of the selected representative video pictures are displayed at once. Accordingly, the selected video pictures are compressed in size so as to fit in the first display area. In some cases, the video pictures are compressed to the point that the content is no longer discernible by a human eye. However, the navigation tool will still illustrate the prominent colors of the clips, from which a human can discern the color rhythm of the video project (i.e., sections that are “warm” (light colors) or “cool” (dark colors)). The difficulty of discerning actual content in the navigation tool and the appearance of the color rhythm are not shown in the simplification of FIG. 1, but are apparent in various figures described below.

As in the example of FIG. 1, the video pictures in the second display area are displayed in a size large enough that the content is discernible by a human user. Some embodiments display one video picture per video clip in the second display area, using the same video pictures that make up the scrollbar. Some embodiments display all of the video pictures in the second display area as the same size (e.g., having the aspect ratio of the video, such as 16:9 or 4:3), while other embodiments display the video pictures having different sizes based on the length of the video clips they represent. In FIG. 1 for instance, the video picture 123 for Clip P is displayed as larger than any of the currently shown frames 121-122 and 124-126 for the other clips, indicating that Clip P is longer than any of these other clips.

The navigation tool as described can be used in a variety of different applications. For instance, the navigation tool of some embodiments is provided in a video-editing application. A user can use the navigation tool to select a video clip for editing (either by selecting directly from the navigation tool or by scrolling through video clips in a second display area). Once the video clip is selected, a user can use editing tools to edit various aspects of the selected clip (e.g., color correction, adding special effects, etc.).

In addition to use in editing applications, the navigation tool can be used in applications for playing a completed composite video presentation. For instance, navigation tools that include one representative video picture per video clip may be used in a DVD player application. In such applications, the video clips are defined as in the editing process in some cases, while in other cases the video clips are defined based on the scenes of the DVD. A viewer of the DVD can use the navigation tool to navigate to a particular scene in the movie (or other video content) that is stored on the DVD.

Similarly, the navigation tool may be provided in applications that play video files other than from DVDs (e.g., personal computer applications such as Quicktime®, applications on handheld devices such as cell phones or media players, etc.) or as the interface for interacting with machines designed specifically for playing DVDs, Blu-Ray®t discs, etc. Finally, the navigation tool can be used to navigate through images rather than video. For instance, if a digital photo album groups photos into “events” or “film rolls” (sets of images that are logically grouped together), then one image from each of several sets could be selected and used to generate the navigation tool of some embodiments.

Several more detailed embodiments of the invention are described in the sections below. Section I provides a description of various ways to generate the navigation tool of some embodiments. Section II describes various ways to navigate a video presentation using the navigation tool. Section III provides descriptions of various applications that use the navigation tool. Section IV follows with a description of the software architecture of one such application, a media-editing application. Finally, Section V describes a computer system which implements some embodiments of the invention.

### I. Generating the Navigation Tool

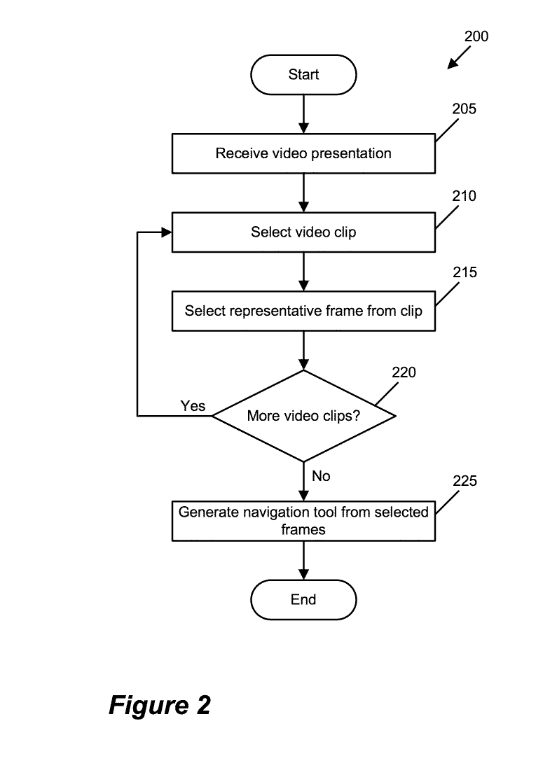

As mentioned above, some embodiments provide a novel navigation tool for navigating through video clips in a video presentation. FIG. 2 conceptually illustrates a process 200 of some embodiments for generating such a navigation tool for a video presentation. In some embodiments, process 200 is performed by a video-editing application (such as a color grading application). In other embodiments, the process 200 is performed by applications for viewing media files (e.g., media file viewing applications, DVD player user interfaces, etc.) or other applications in which a user wants to navigate a video presentation. As shown, process 200 receives (at 205) a video presentation. The video presentation of some embodiments is similar to that of FIG. 1 above, in that it is composed of an ordered series of video clips.

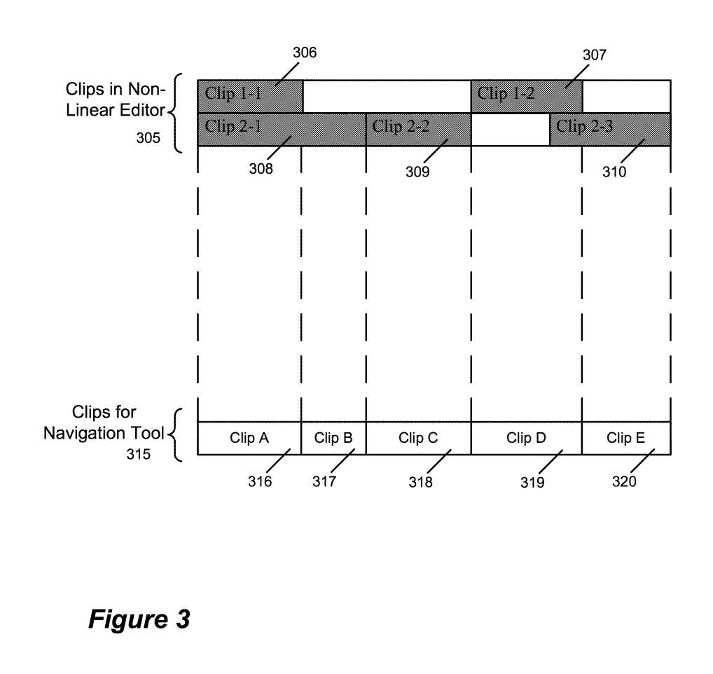

FIG. 3 conceptually illustrates a portion of a video presentation that is created by compositing a set of clips. Specifically, FIG. 3 illustrates a set of clips 305 as defined in a non-linear editor that creates composite video presentations and a set of clips 310 in the created composite video presentation. The clips 305 correspond to separate files in some embodiments that are rendered together to form the composite video presentation.

A non-linear editing application can include multiple overlapping tracks of video. For instance, Clip 1-1 (306) and Clip 2-1 (308) overlap in the composite presentation, and Clip 1-2 (307) and Clip 2-3 (310) also overlap. Such overlaps might occur when there is animation (credits, graphics, etc.) displayed over a main video clip. Such overlaps can also occur from a user simply assigning multiple video clips to different tracks over the same time period. In some embodiments, the non-linear editor has a hierarchy of tracks such that if a first clip is assigned to one track and a second clip is assigned to a second track over the same time period as the first clip, the non-linear editor renders whichever clip is on a track that is higher in the hierarchy.

For the purpose of generating the navigation tool, some embodiments require that the clips be arranged without overlap. Accordingly, some embodiments define clips for the navigation tool based on the clips in the non-linear editor. In the example of FIG. 3, the upper track is assumed to have precedence in the hierarchy of tracks. Thus, Clip A (316) corresponds to Clip 1-1 (306) and Clip B (317) corresponds to the remainder of Clip 2-1 (317) after Clip 1-1 (306) has ended. Clip C (318) corresponds to Clip 2-2 (309). Clip 1-2 (307) takes precedence over Clip 2-3 (310), so Clip D (319) corresponds to the entire length of Clip 1-2 (307). Clip E (320) then corresponds to the remainder of Clip 2-3 (310) that is after the end of Clip 1-2 (307).

Different embodiments might define the clips differently, however. For instance, some embodiments allow a user to further refine the breaks between video clips in the non-linear editing application. For instance, a user might know that Clip 2-1 (308) and Clip 2-2 (309) were shot from the same location and are intended to look like one video clip in the rendered final presentation. As such, the user could manually remove the boundary between Clip B (317) and Clip C (318) such that these would be combined into one video clip. In some embodiments, a video presentation will have a main track that is composed of video clips that are successively played and various other tracks that include insets, overlaid graphics, animations, and text, etc. In such cases, some embodiments treat only the video clips in the main track as the video clips from which the navigation tool is generated, ignoring all the various insets and overlays.

Returning to process 200, the process next selects (at 210) a video clip. In some embodiments, video clips are selected successively (i.e., referring to video presentation 150 of FIG. 1, Clip 1 (156) would be selected first, then Clip 2 (157), etc.). Other embodiments select the video clips non-successively (e.g., randomly).

Next, the process selects (at 215) a representative video picture (i.e., a frame, field, or other unit of digital video) for the selected clip to be used in generating the navigation tool. Different embodiments select the representative video picture for a particular clip differently. Some embodiments select the representative video picture based on its location in the video clip. For instance, some embodiments always select the first video picture of a clip as the representative video picture for the clip. Other embodiments select the middle video picture of a clip (i.e., if the clip has 99 video pictures, the 50^{th} video picture is the middle) as the representative frame. Still other embodiments select a video picture that is a particular number of video pictures into the video clip. For instance, the first video picture of some clips might not be very representative of the color properties of the clip, so the 50^{th} (or 100^{th}, 300^{th}, etc.) might be chosen instead.

Alternatively, the representative video picture may be selected based on an analysis of one or more properties of the video pictures of the clips. For instance, color properties of the clips might be analyzed, and a frame most representative of the colors of the various frames in the video clip would be selected. Analysis of the objects of the video picture is also done in some embodiments in order to determine a representative video picture. For example, some embodiments could determine the various content objects (e.g., people, cars, buildings, trees, etc.) present in a particular video clip, then select a video picture that best represents the content objects. Some embodiments select all representative video pictures in the same way (e.g., the first video picture from each video clip), while other embodiments use different techniques for the various representative video pictures.

Next, process 200 determines whether there are more video clips in the video presentation that have not been analyzed. When there are more video clips to analyze, the process proceeds to 210 to select another video clip. When representative frames have been selected for all video clips in the video presentation, the process generates (at 225) a navigation tool from the selected frames. In some embodiments, generating the navigation tool entails compressing the selected video pictures to fit into a predetermined area such that all of the video pictures are displayed at once.

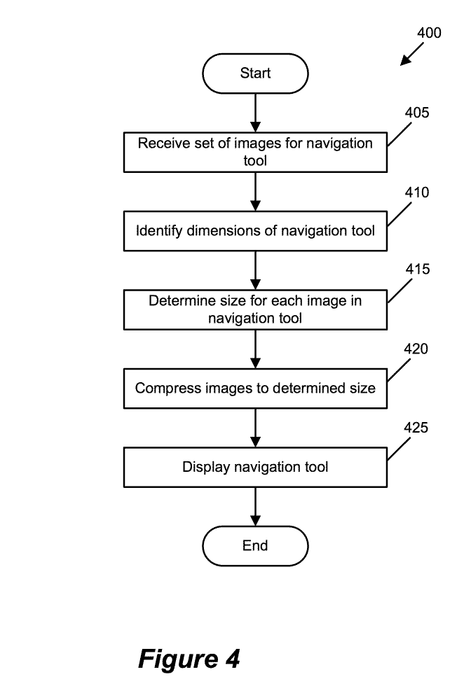

FIG. 4 conceptually illustrates a process 400 of some embodiments for generating a navigation tool from a set of images. In some embodiments, process 400 is performed as operation 225 of process 200 to generate a navigation tool for a video presentation. However, process 400 is applicable to any set of images, such as images representing sections of digital photo albums.

As shown, process 400 receives (at 405) a set of images for the navigation tool. In some embodiments, the received images are representative video pictures for the various video clips in a composite video presentation. As described above, the representative video picture for a particular video clip could be based on position in the video clip, properties of the video pictures of the video clip, etc. The received images could also be selected photographs from a number of digital photo albums (i.e., a set of images grouped together as representing one film roll or event).

Next, the process 400 identifies (at 410) dimensions of the navigation tool. Some embodiments require all of the images in the navigation tool to be displayed concurrently in a fixed area. Accordingly, the process identifies the dimensions of the fixed area in which the navigation tool is to be displayed. The area is determined in some embodiments by the application for which the navigation tool is to be used. For instance, in a media-editing application, the navigation tool might take up only a portion of the display area for the application, whereas in a video playing application the navigation tool might take up the entire bottom of the display of the application.

Once the dimensions of the navigation tool are identified, the process determines (at 415) the size for each image in the navigation tool. In some embodiments, the navigation tool is a horizontal arrangement of all of the images in the set of images. When the set of images is the set of representative video pictures for all of the video clips in a video presentation, some such embodiments arrange the video pictures in the order of the video clips they represent, such that the video picture for the first video clip in the presentation is at the left end of the navigation tool and the video picture for the last video clip in the presentation is at the right end. In such embodiments, the width for each image W_{I} is the total width W for the navigation tool divided by the total number of images N, such that W_{I}=W/N. The height of each image is the same as the height of the navigation tool.

Similarly, some embodiments arrange the images vertically. When the set of images is the set of representative video pictures for all of the video clips in a video presentation, some such embodiments arrange the video pictures such that the video picture for the first video clip in the presentation is at the top of the navigation tool and the video picture for the last video clip in the presentation is at the bottom of the navigation tool. In such embodiments, the height for each image is the total height of the navigation tool divided by the total number of images and the width of each image is the width of the navigation tool.

Other embodiments arrange the images differently. For example, the images could be arranged in two dimensions (e.g., in a square). Or the images could be arranged primarily horizontally, but in two rows stacked on top of each other. Furthermore, some embodiments determine a different size for each image in the navigation tool (e.g., based on the length of the video clip represented by the image).

After the size for each image is determined, process 400 compresses (at 420) the images to the determined size or sizes. Obviously, in scaling an image by large scale factors (e.g., 10, 100, 500, etc., depending on the allotted dimensions of the navigation tool and the number of images that must fit in the navigation tool) a great deal of visual data will be lost. To scale the images, some embodiments use standard scaling/compression mechanisms that are regularly used in image editing software.

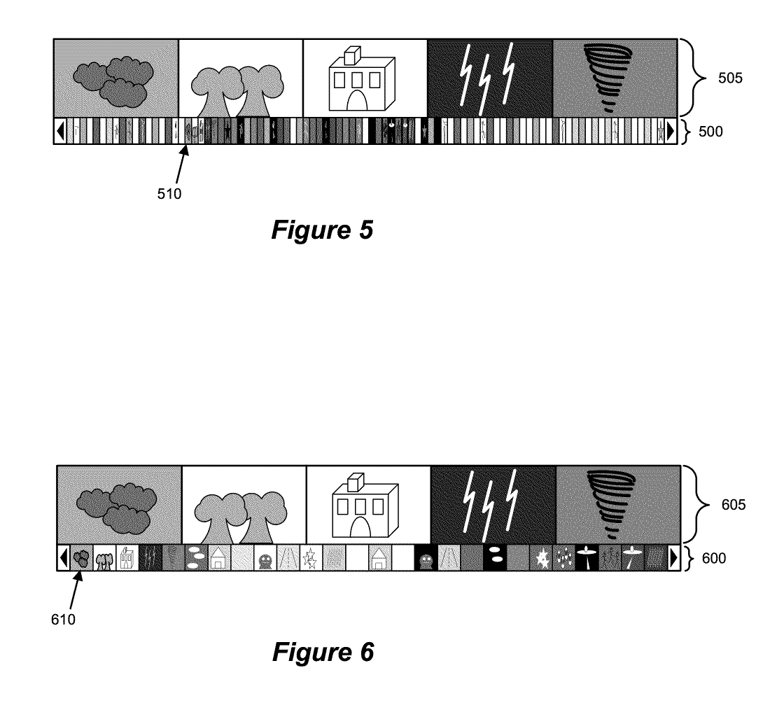

Next, the process displays (at 425) the navigation tool. FIGS. 5 and 6 illustrate examples of displayed navigation tools of some embodiments. The example navigation tools 500 and 600 are shown as scrollbars that enable a user to scroll through a series of images 505 and 605. However, as will be described in the following section, the navigation tools need not necessarily be scrollbars.

FIG. 5 illustrates navigation tool 500 that includes 91 equally-sized images. As the navigation tool is arranged horizontally, the width of each of the images is the width of the entire navigation tool divided by 91. Above the navigation tool 500 is a series of images 505 that are much larger in size than those in the navigation tool 500 itself. In some embodiments, as shown, the images 505 are the same images that are used in the navigation tool. In the series of images 505, each of the images is displayed as the same size. Other embodiments display the images as different sizes (e.g., varying the size based on the length of the clip the image represents). Some embodiments allow a user to scroll through the series of images (e.g., images 505) by using the navigation tool (e.g., navigation tool 500).

FIG. 6 illustrates navigation tool 600 that includes 26 equally-sized images. As the navigation tool is arranged horizontally, the width of each of the images is the width of the entire navigation tool divided by 91. As can be seen by comparing FIG. 5 to FIG. 6, the images in navigation tool 500 are substantially smaller than those in navigation tool 600, as they were compressed more in order to generate navigation tool 500.

While it is more difficult to discern the content of any particular image in navigation tool 500 as compared to navigation tool 600 (compare, e.g., image 510 with image 610), navigation tool 500 illustrates the color rhythm of the images (which, in some cases, corresponds to the color rhythm of a video presentation) quite well. The images clearly go from generally lighter to a dark section in the middle to a substantially lighter ending. The use of these navigation tools to actually navigate through a video presentation or other series of images will be described in detail in the next section.

II. Navigating with the Navigation Tool

The navigation tool of some embodiments can be used in different ways to navigate a video presentation. For instance, some embodiments use the navigation tool as a scrollbar that enables scrolling through the video clips of a video presentation. Some embodiments use the navigation tool to enable selection of a video clip (for viewing, editing, etc.), and some embodiments combine the scrolling and selection features.

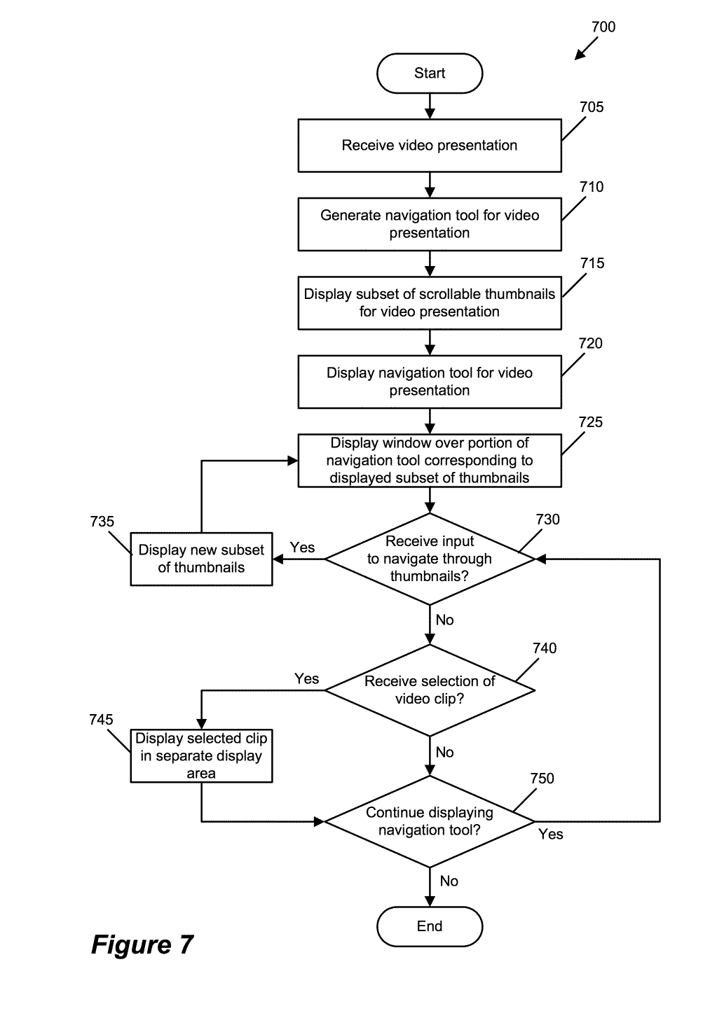

FIG. 7 conceptually illustrates a process 700 of some embodiments for navigating a video presentation with such a navigation tool. As shown, process 700 receives (at 705) a video presentation that is composed of an ordered series of video clips. The video presentation could be a movie, a documentary, a television show, an animated short, etc. The process then generates (at 710) a navigation tool for the video presentation. The process uses process 200 and/or 400 in some embodiments to generate the navigation tool. In some cases, the generated navigation tool is similar to navigation tools 500 and 600 of FIGS. 5 and 6.

Next, the process displays (at 715) a subset of scrollable thumbnail images for the video presentation and displays (at 720) the navigation tool. While process 700 is shown as displaying the thumbnails before displaying the navigation tool, one of ordinary skill in the art will recognize that some embodiments might display the navigation tool before displaying the thumbnails, or display them both at the same time. Some embodiments also display, in a separate display area, the video presentation starting from the first video clip.

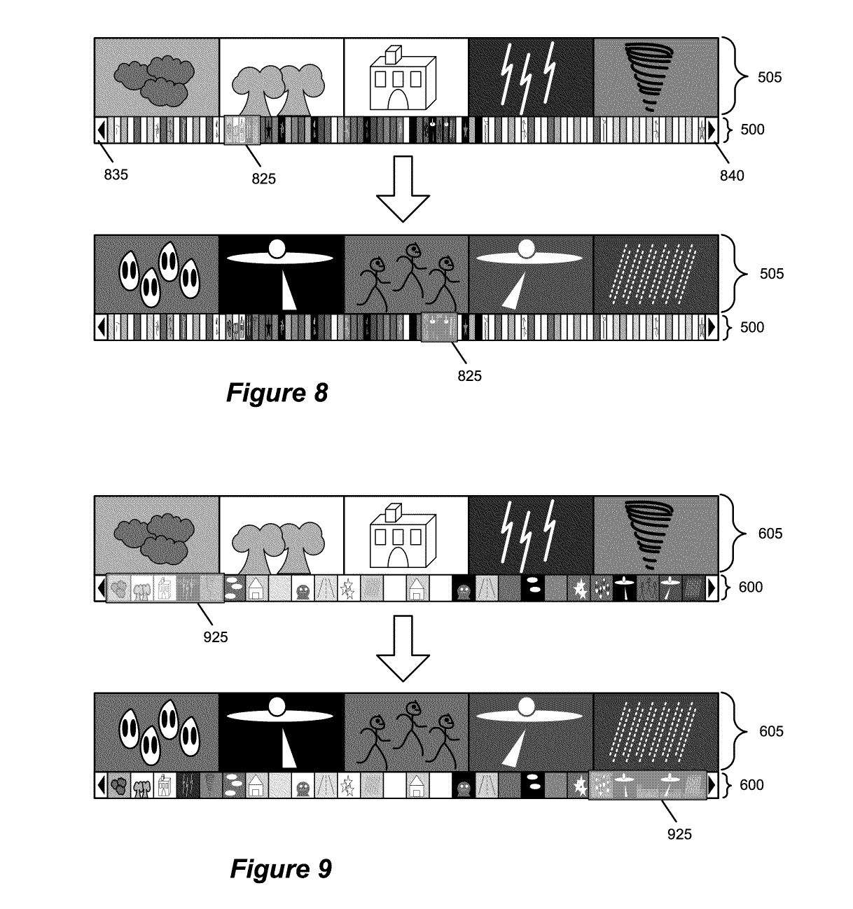

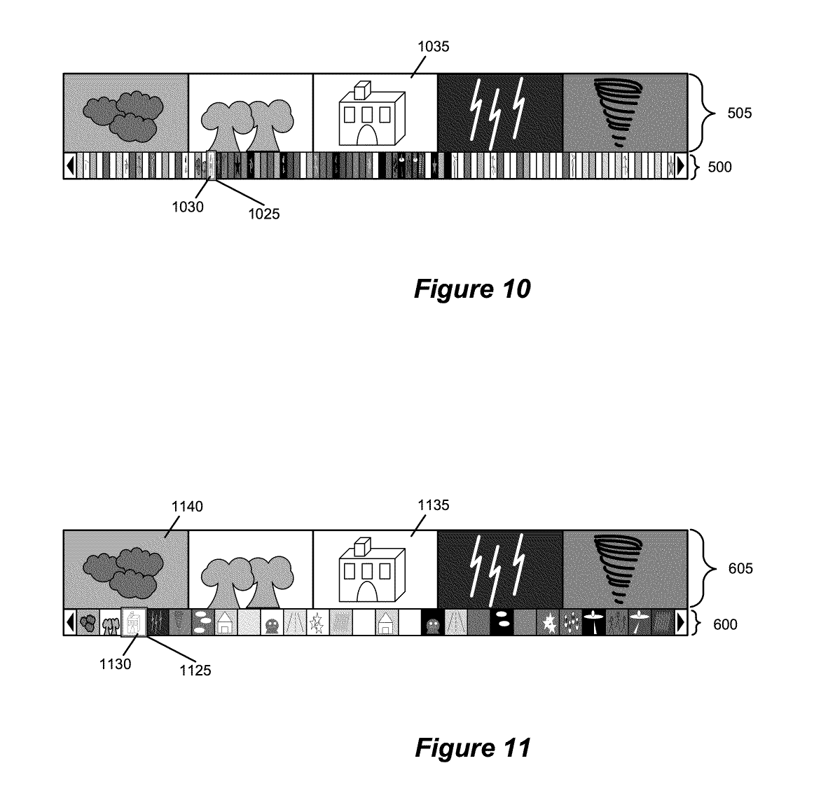

FIG. 8 illustrates navigation tool 500 and thumbnail images 505. In some embodiments, as shown, the thumbnail images are larger versions of the images used to generate the navigation tool. Each of the images 505 represents one of the video clips in the video presentation for which navigation tool 500 is generated. A user, using various navigational features of the navigation tool, can scroll through the images 505 and select video clips, as described below. Similarly, FIG. 9 illustrates navigation tool 600 and images 605, and each of the images 605 represents one of the video clips in the video presentation for which navigation tool 600 is generated.

Process 700 next displays (at 725) a window over the portion of the navigation tool that corresponds to the displayed subset of thumbnail images. The window, in some embodiments, acts like a thumb or elevator of a scrollbar—i.e., a knob that can be dragged by a user to scroll through the thumbnails. FIG. 8 illustrates window 825 over the five images in navigation tool 500 that correspond to the five images currently displayed in the series of images 505.

In embodiments that display the window over all of the images in the navigation tool that correspond to the displayed subset of thumbnails (as is the case with window 825), the window will vary in size along with the size of the images that make up the navigation tool. By comparison, FIG. 9 illustrates window 925 over the five images in navigation tool 600 that correspond to the five images currently displayed in the series of images 605. Window 925 is noticeably larger than window 825 because the size of the images in navigation tool 600 is larger than those in navigation tool 500.

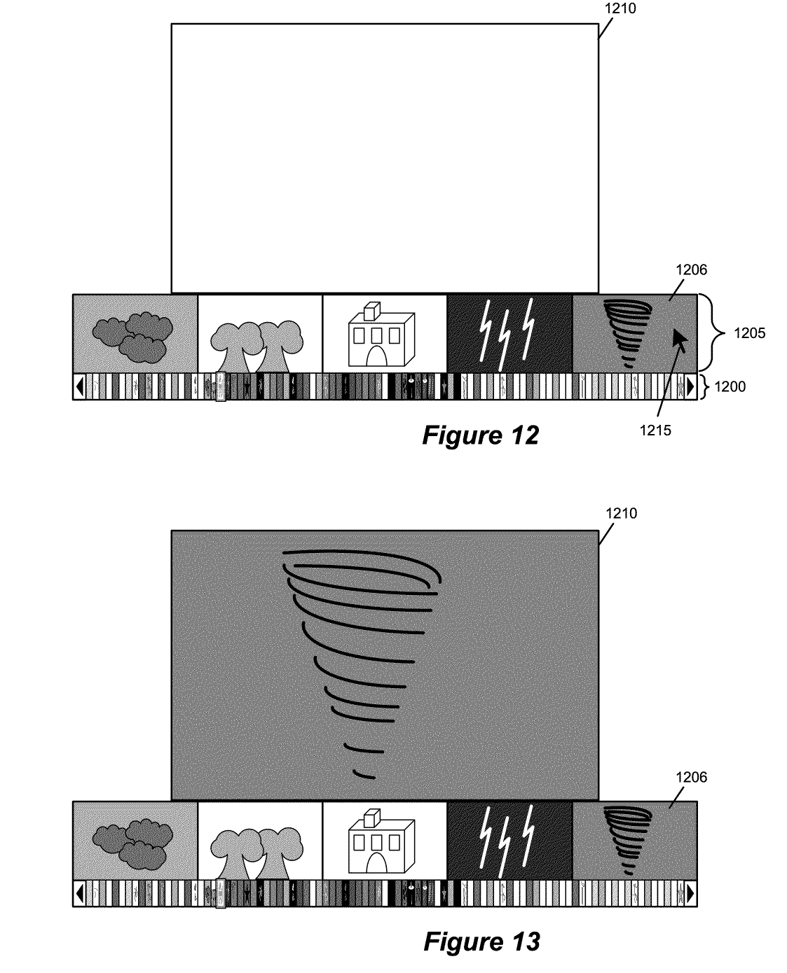

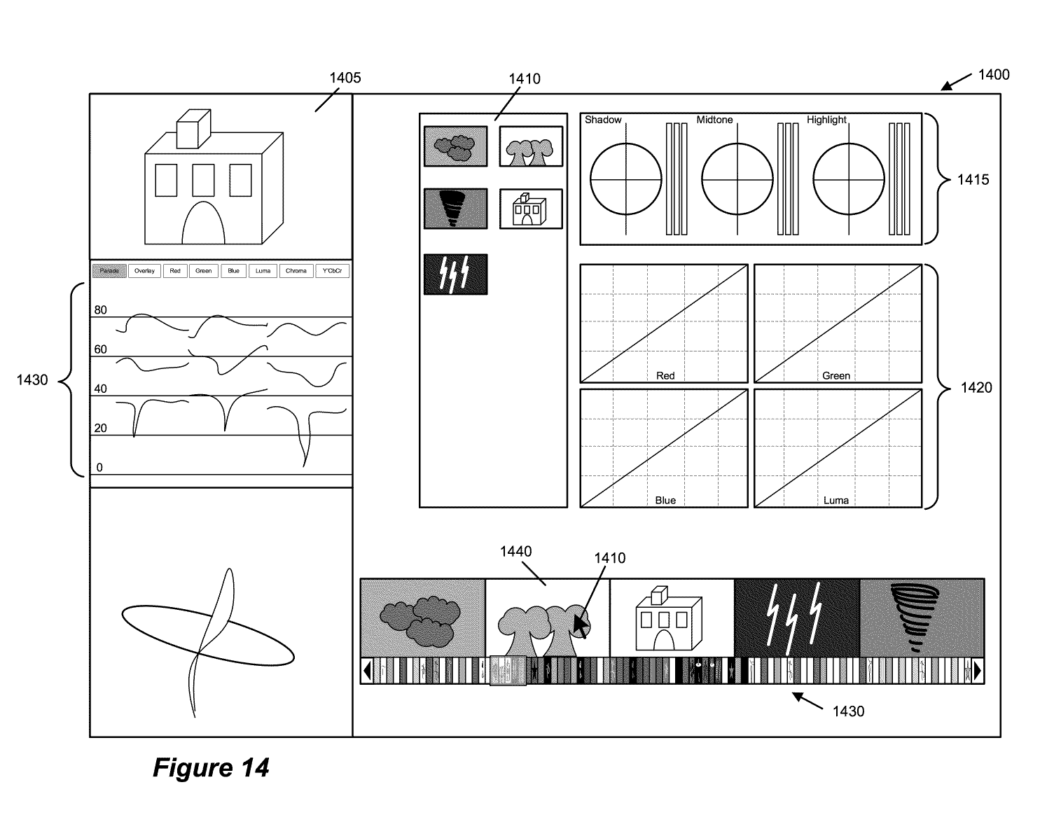

Some embodiments display a window that only covers one of the images in the navigation tool rather than the entire set of images that is displayed in the larger view. FIGS. 10 and 11 illustrate navigation tools 500 and 600, respectively, with such windows. FIG. 10 illustrates window 1025 over a single image 1030 in the navigation tool 500. The image 1030 corresponds to the larger image 1035 displayed in the scrolling series of images. In some embodiments, as shown, the image in the center of the scrolling series of images is the image over which the window is displayed.

FIG. 11 similarly illustrates window 1125 over a single image 1130 in the navigation tool 600. The image 1130 corresponds to the larger image 1135 displayed in the center of the scrolling series of images. The series of images 605 can not be scrolled any further to the left, as the first image 1140 corresponds to the first video clip in the video presentation for which the navigation tool 600 was generated. As such, the window 1125 cannot be moved any further to the left. In some embodiments, however, a user can scroll in a circular fashion, in that moving the window 1125 to the left will cause the scrolling series of images 605 to include images from the end of the video presentation.

After the initial display of the navigation tool, window, and portion of the video presentation, process 700 determines (at 730) whether any input has been received to navigate through the thumbnail images. When no such input has been received, the process proceeds to 740, which is described below. When input is received to navigate through the thumbnails, the process displays (at 735) a new subset of the thumbnail images. In embodiments such as those shown in FIGS. 8 and 9, this entails scrolling through the images 505 or 605. The process also returns to 725 and displays the window over the portion of the navigation tool corresponding to the displayed subset of thumbnail images.

The bottom portion of FIG. 8 illustrates the result of input to navigate through the series of images 505 for the 91-clip video presentation using navigation tool 500. New images from the series of images 505 are now displayed, corresponding to different video clips. Furthermore, the window 825 has moved to a different portion of the navigation tool 500 that corresponds to the images now shown from the series of images 505. Similarly, the bottom portion of FIG. 9 illustrates the result of input to navigate through the series of images 605 for the 26-clip video presentation using navigation tool 600. New images from the series of images 605 are now displayed, corresponding to different video clips. Furthermore, the window 925 has moved to the end (right side) of the navigation tool 600 that corresponds to the images now shown from the series of images 605.

The received input to navigate through the thumbnail images can be in a variety of different forms in some embodiments. In some embodiments, a user can select (e.g., with a cursor control device such as a mouse, touchpad, etc.) the window and move the window along the navigation tool, thereby resulting in the scrolling of the thumbnail images. For instance, in FIG. 8, a user could have placed the cursor over the window 825, grabbed the window (e.g., by pressing and holding a mouse button), and then dragged the window to the right. In some embodiments, as the window moves along the navigation tool, the larger thumbnail images representing the video presentation scroll in the opposite direction. As a user starts moving window 825 to the right, the images 505 displayed at the top of FIG. 8 will move out of their display area to the left as new images 505 enter from the right.

Some embodiments also allow a user to use scroll arrows, such as scroll arrows 835 and 840. Selecting the left scroll arrow will cause the window to move to the left as the thumbnail images scroll to the right. Selecting the right scroll arrow will cause the window to move to the right as the thumbnail images scroll to the left. For instance, in FIG. 9, a user could have placed the cursor over the right scroll arrow 940 and selected the arrow (e.g., by pressing and holding a mouse button) until the window 925 had moved all the way along navigation tool 600 to the far right end. In some embodiments, as the window moves along the navigation tool in response to the scroll arrows, the thumbnail images representing the video presentation scroll in the opposite direction. As a user starts selecting right scroll arrow 940, the images 605 displayed in the top portion of FIG. 9 will move out of their display area to the left as new images 505 enter the display from the right.

Other mechanisms for navigating through the thumbnail images are available in some embodiments as well. A user can select an image in the navigation tool (e.g., by moving a cursor over the image and pressing a cursor control button) in order to jump the displayed larger images to that particular image. Some embodiments also allow a user to place the cursor in the display area where the larger images are displayed and drag the images in order to scroll through them.

When process 700 determines that no input is received to navigate through the thumbnails, the process determines (at 740) whether a selection of a video clip is received. When input selecting a video clip is received, the process displays (at 745) the selected video clip in a separate display area. In some embodiments, displaying the selected video clip entails playing the video presentation starting from the beginning of the selected video clip.

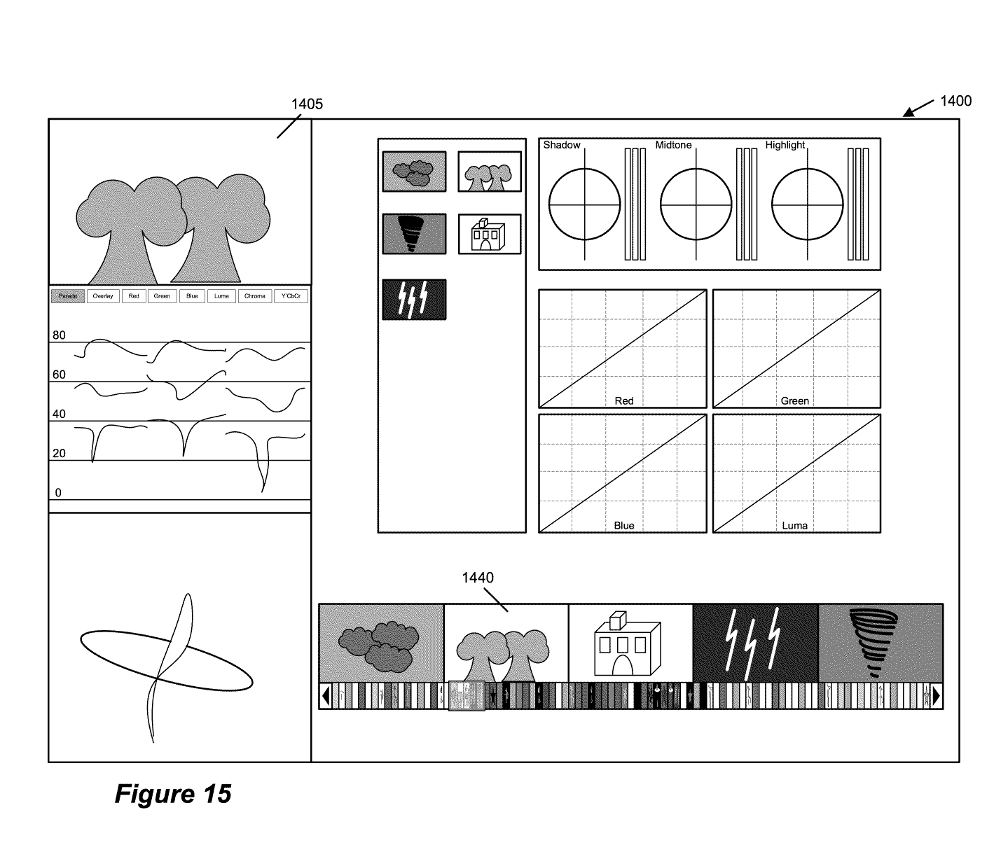

FIG. 12 illustrates a navigation tool 1200, a series of larger scrolling images 1205, and a display area 1210. At present, no image is shown in the display area 1210. In some embodiments, an image can be selected from the navigation tool or thumbnails by a user to be shown in the display area 1210. The image or corresponding video clip can then be edited in some embodiments (i.e., when the navigation tool is part of a media-editing application). If the image is a representative video picture for a video clip, the video clip can be played for viewing in some embodiments (i.e., when the navigation tool is part of a digital media player application).

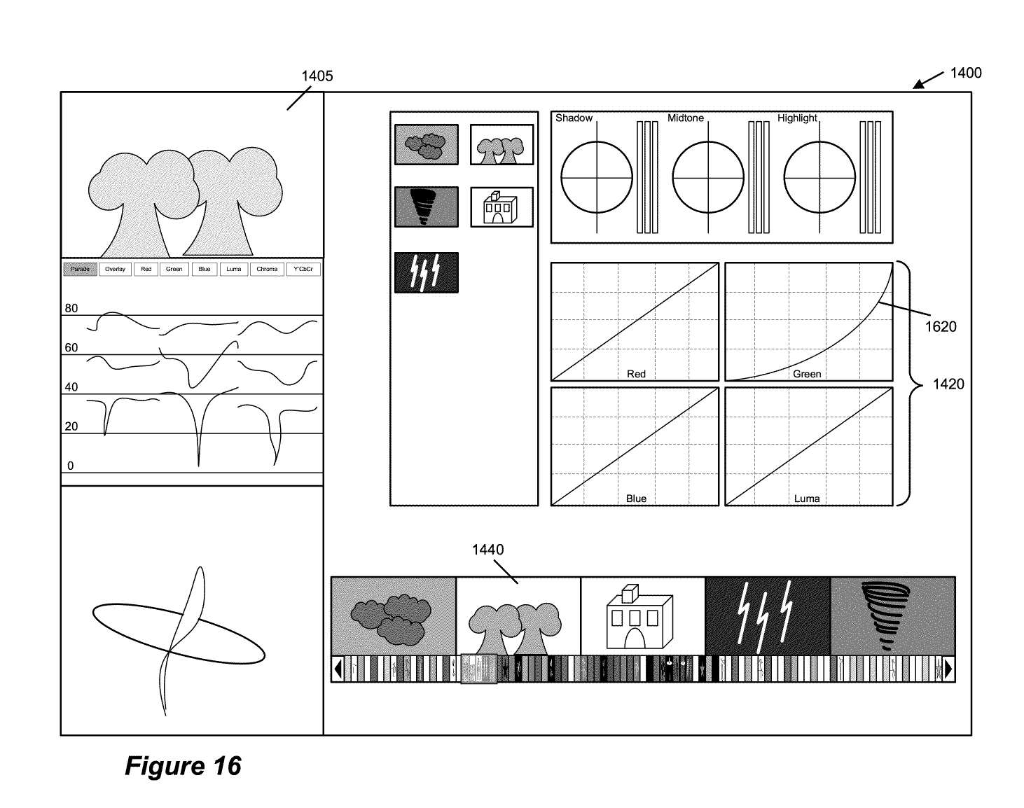

FIG. 12 also illustrates a cursor 1215 over the larger image 1206 from the series of images 1205. FIG. 13 illustrates the result of the user selecting image 1206 (e.g., by pressing and releasing a mouse button over image 1206), such that a larger version of image 1206 is displayed in display area 1210 (e.g., for editing, viewing, etc.).

Some embodiments enable a user to select an image or video clip for display in the separate display area (e.g., display area 1210) directly from the navigation tool itself. For instance, in some embodiments, a user can perform a selection command (e.g., clicking, double-clicking, etc.) with a cursor over a particular image in the navigation tool such that a version of the particular image will be displayed in the separate display area. This is also the case in some embodiments that do not have a scrolling series of images such as images 1205.

Returning to FIG. 7, process 700 next determines (at 750) whether to continue displaying the navigation tool. In some embodiments, the process continues displaying the video presentation until a user closes the application that includes the navigation tool, or selects an option within the application to remove the navigation tool from the display. When the process determines to continue displaying the navigation tool, the process returns to 730 to continue determining whether input is being received. Otherwise, the process ends.

Some embodiments enable a user to interact with the navigation tool by using a touchscreen. In such embodiments, the navigation tool (and video presentation) are displayed on the touchscreen. Rather than using a cursor controlled by a cursor controller such as a mouse, the user interacts directly with the touchscreen (in fact, in some embodiments, there is no cursor). For instance, to navigate through the thumbnails in some embodiments, the user places a finger over the window and moves the window to the right or left. Similarly, the user can select a video clip by double-tapping on the screen over a particular thumbnail in some embodiments (or similar selection input).

One of ordinary skill in the art will recognize that other processes similar to process 700 are possible. For instance, some embodiments do not display the scrolling thumbnail images, and instead use the navigation tool to navigate through the video presentation directly. Process 700 and other, similar processes can be used by a variety of different applications to navigate a video presentation. The following section describes a number of these applications in greater detail.

### IV. Uses of the Navigation Tool

In some embodiments, the navigation tool as described above is incorporated into a larger application. For instance, when the navigation tool is for navigating video, it could be incorporated into a digital media player (e.g., Apple Quicktime® or Microsoft Windows Media Player®), a video editing application (e.g., Apple Color®), or even the user interface of a specialized electronics device such as a DVD player or Blu-Ray® player. When the navigation tool is for navigating through groups of images, it could be incorporated into a digital photobook (e.g., Apple iPhoto®) or an image-editing application (e.g., Apple Aperture®) or Adobe Photoshop®).

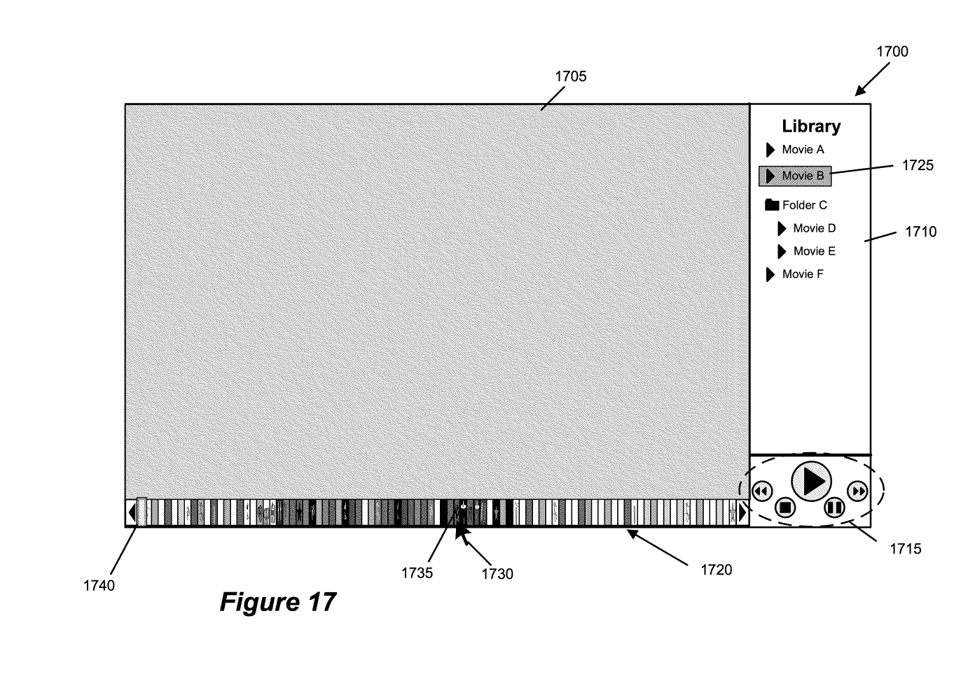

FIGS. 14-16 illustrate the use of a video-editing application that incorporates the navigation tool of some embodiments. Specifically, FIGS. 14-16 illustrate the use of the navigation tool to select a video clip from a composite video presentation for editing and then the use of color correction tools to apply color correction to the video clip. While FIGS. 14-16 illustrate a video-editing application, one of ordinary skill in the art will recognize that the same or similar features (e.g., color correction tools) will be present in image-editing applications that embody the invention as well.

FIG. 14 illustrates video-editing application 1400 that incorporates a navigation tool 1430. In addition to navigation tool 1430, video-editing application includes a main editing window 1405, a set of selectable clips 1410, a first set of color correction tools 1415, a second set of color correction tools 1420, and indicator graphs 1425. The editing window 1405 displays an image (e.g., a frame or field) of a video clip that is presently being edited. In some embodiments, a user can view edits to the image in edit window 1405 as the various editing tools are used in order to judge whether the edit is actually desired.

The set of selectable clips 1410 includes a set of clips that are available to a user for editing. In some cases, the clips 1410 are clips within a video presentation that have already been edited, while other clips are selectable only through navigation tool 1430. For shorter video presentations, some embodiments display all of the clips in the video presentation among clips 1410. Other embodiments have different selection criteria for determining which video clips should be present among clips 1410.

The first set of color correction tools 1415 includes color wheels and sliders for editing shadow, midtone, and highlight in the image displayed in editing window 1405. The second set of color correction tools 1420 includes curves for adjusting red, green, blue, and luma values. Adjusting the red curve, for instance, will only affect the red values of the pixels in the image displayed in editing window 1405. When a region of interest is defined for the image, then adjusting the red curve will only affect the red values of the pixels in the region of interest. The indicator graphs 1425 illustrate the spread of color values throughout the image displayed in editing window 1405.

As shown in FIG. 14, three graphs (for red, green, and blue values) are displayed. Selecting one of the items above the indicator graphs (overlay, red, green, blue, luma, chroma, Y′CbCr) will display a graph for just the selected item. In some embodiments, edits made using the sets of color correction tools are reflected in the graphs 1425. For instance, edits made using the red curve will modify the indicator graph for the red values.

In some embodiments, an edit made to the image displayed in editing window 1405 is in fact made for the entire video clip of which the image is a part. While this is not necessarily difficult for edits applied to the entire image, some embodiments include selection tools that allow a user to select a region of interest and only apply edits to the region of interest. Such a region will often move throughout the course of a video clip. For instance, if the region of interest is a person, then the person may move during the course of the video clip. Some embodiments can recognize this motion (via edge detection, color value comparisons, or other techniques) and move the region of interest along with a particular object or objects in a video clip.

The navigation tool 1430 includes a representative video picture from each of the video clips in the video presentation. In some embodiments, navigation tool 1430 is generated according to processes 200 and 400 and can be used to navigate the video presentation according to process 700, all of which are described above. A user can use navigation tool 1430 to select a particular video clip for editing in some embodiments. Some embodiments generate the navigation tool when a user selects the particular video presentation for editing, whereas other embodiments generate a navigation tool beforehand (or at least determine the representative video pictures) and store the navigation tool with the video presentation.

FIG. 14 also illustrates cursor 1435 over image 1440 that is part of the scrolling series of images that can be scrolled through using navigation tool 1430. FIG. 15 illustrates the video-editing application 1400 after the user has selected image 1440 from the scrolling series of images. This image is now displayed in editing window 1405, thus allowing for edits to be applied to the image (and the other video pictures in the video clip as well).

FIG. 16 illustrates the result of a user modifying the green curve 1620 among the second set of color correction tools 1420. The green curve 1620 has been modified to lower the green values for all pixels in the image. As such, the indicator graphs 1625 for the green values have changed, and the green trees are now lighter in color in editing window 1405. The lowering of the green values is applied to all video pictures in the video clip represented by image 1440 in some embodiments. Furthermore, some embodiments allow a user to save this edit and apply the same edit to other video clips in the video presentation. A user might want to do this if another video clip was filmed at the same location on the same day and would thus have similar color properties.

One of ordinary skill will recognize that the media-editing tools and processes that are described above can be incorporated into any media-editing application by way of a plug-in, applet, or direct function incorporated within the application itself. Accordingly, different image-editing applications (e.g., Apple Aperture®, Apple iPhoto®, Adobe Photoshop®, Adobe Lightroom®, etc.) or video-editing applications (e.g., Apple Final Cut Pro®, Apple Color®, Avid®, etc.) may each implement one or more of the media-editing tools described herein. Additionally, the media-editing tools and processes described above and below can be incorporated within the functionality of any other application (e.g., digital photo albums, etc.), or within an operating system (e.g., Microsoft Windows®, Apple Mac OS®, etc.).

Furthermore, one of ordinary skill will recognize that many image- and video-editing features not shown in 1400 may also be part of a media-editing application that incorporates the invention. For instance, some embodiments might have other color correction tools, such as tools to change saturation, hue, balance, etc., or might have tools for adding various effects to an image or a region of interest of an image.

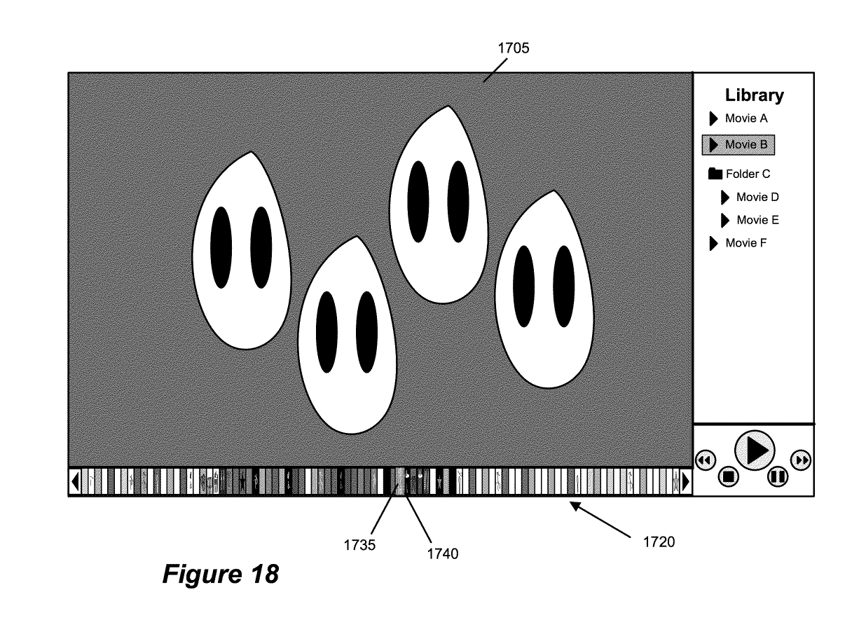

FIGS. 17 and 18 illustrate a media player application 1700 that incorporates the navigation tool of some embodiments. Media player 1700 includes a display area 1705, a library 1710, a set of player tools 1715, and navigation tool 1720. Display area 1705 displays a video for a user to watch. Library 1710 displays videos from which a user can choose. When a user selects a video from the library, the video is displayed in display area 1705 and a navigation tool for the video is displayed below. The set of player tools 1715 includes the standard tools for watching a video (play button, fast forward and rewind, stop, pause). Navigation tool 1720, in some embodiments, is a navigation tool generated by processes 200 and 400. In some embodiments, navigation tool 1720 does not include a scrolling set of larger images, as shown, though some embodiments do include these images.

FIG. 17 illustrates that Movie B has been selected from the library, and thus is highlighted. Upon selection of Movie B from the library, the navigation tool 1720 for Movie B is displayed below display window 1705 and the start of Movie B is displayed in the display window. Window 1740 is also displayed over the first video picture in the navigation tool, indicating the location in the video presentation of the currently playing video clip. Some embodiments generate the navigation tool when a user selects the particular video presentation for viewing, whereas other embodiments generate a navigation tool beforehand (or at least determine the representative video pictures) and store the navigation tool with the video presentation.

FIG. 17 also illustrates a cursor 1730 that is over a video picture 1735 in the navigation tool 1720. In some embodiments, a user selecting a particular video picture in navigation tool 1720 causes the video presentation to jump (either forwards or backwards) to the particular video clip with which the particular video picture is associated. FIG. 18 illustrates the result of selecting video picture 1735 (e.g., by pressing and releasing a mouse button). The display area 1705 is now displaying the video clip with which video picture 1735 is associated, and window 1740 has moved over the selected video picture 1735.

One of ordinary skill will recognize that the media player features that are described above can be incorporated into any media player application by way of a plug-in, applet, or direct function incorporated within the application itself. Accordingly, different media player applications (e.g., Apple Quicktime®, Real Player®, Microsoft Windows Media Player®, etc.) may each implement one or more of the image-editing tools described herein. Additionally, the media player tools and processes described above can be incorporated within the functionality of any other application (e.g., media-editing applications, etc.), or within an operating system (e.g., Microsoft Windows®, Apple Mac OS®, etc.). Furthermore, one of ordinary skill will recognize that many media player features not shown in application 1700 may also be part of a media player application that incorporates the invention.

### V. Software Architecture

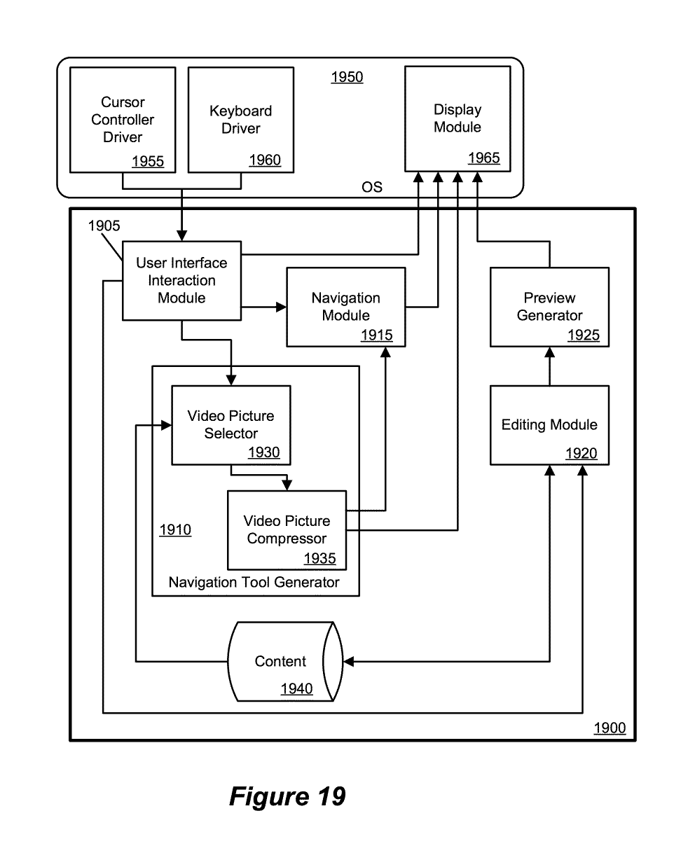

In some embodiments, the processes described above are implemented as software running on a particular machine, such as a computer or a handheld device, or stored in a computer readable medium. FIG. 19 conceptually illustrates the software architecture of a media-editing application 1900 of some embodiments for editing images and/or videos. In some embodiments, the application is a stand-alone application or is integrated into another application (for instance, the modules illustrated in FIG. 19 might only be a subset of the modules in a media-editing application), while in other embodiments the application might be implemented within an operating system. Furthermore, in some embodiments, the application is provided as part of a server-based solution. In some such embodiments, the application is provided via a thin client. That is, the application runs on a server while a user interacts with the application via a separate machine remote from the server. In other such embodiments, the application is provided via a thick client. That is, the application is distributed from the server to the client machine and runs on the client machine. Also, application 1900 is a media-editing application; some of the modules in application 1900 could also be present in a media player application that implements the invention.

Media-editing application 1900 includes a user interface (UI) interaction module 1905, a navigation tool generator 1910, a navigation module 1915, an editing module 1920, and a preview generator 1925. The navigation tool generator 1910 includes a video picture selector 1930 and a video picture compressor 1935. The media-editing application also includes content storage 1940. In some embodiments, other storages are present as well, which may be part of the same physical storage as content storage 1940 or stored separately. FIG. 19 also illustrates an operating system 1950 that includes cursor controller driver 1955, keyboard driver 1960, and display module 1965. In some embodiments, as illustrated, the cursor controller driver 1955, keyboard driver 1960, and display module 1965 are part of the operating system 1950 even when the media-editing application is a stand-alone application separate from the operating system.

The UI interaction module 1905 generates some user interface items, such as the various color correction tools described above with respect to FIG. 14, and determines how they should be displayed within the media-editing application. The UI interaction module 1905 passese this information to display module 1965, which enables the display of the media-editing application, including the user interface items, on a computer monitor or other such display device (not shown).

A user interacts with the user interface via input devices (not shown). The input devices, such as cursor controllers (mouse, tablet, touchpad, etc.) and keyboards, send signals to the cursor controller driver 1955 and keyboard driver 1960, which translate those signals into user input data that is provided to the UI interaction module 1905. The UI interaction module uses the user input data to modify the displayed user interface items. The UI interaction module also passes data on user interactions to the navigation module (1915) and the navigation tool generator 1910).

Navigation tool generator 1910 generates a navigation tool for a video presentation. Navigation tool receives a selection of a video presentation for which a navigation tool is to be generated from UI interaction module 1905. The video picture selector 1930 receives information about the video presentation from 1940 and selects one video picture for each video clip in the video presentation. These selected video pictures are sent to frame compressor 1935 which determines the dimensions of the video pictures and compresses them to the appropriate size. In some embodiments, processes 200 and 400 are performed at least partially by navigation tool generator 1910. The generated navigation tool is sent to the navigation module 1915 for use in navigating the video project and to the display module 1965 for display.

The navigation module 1915 receives information from the UI interaction module to navigate a video presentation using a navigation tool. For instance, the information could be selection of a window to move the window along a navigation tool, selection of scroll arrows, or selection of a particular video picture. The navigation module translates this information and sends the translated information to the display module to modify the display of the navigation tool and the associated thumbnail images and/or video presentation.

The editing module 1920 performs the actual editing of the media content (i.e., videos, images, etc.), which is stored in content storage 1940. The editing module 1920 receives information from the UI interaction module 1905, such as input affecting color correction tools and other editing tools. After editing the content, the editing module 1920 stores the edited content in content storage 1940.

Preview generator 1925 enables the output of audio and video from the media-editing application application. The preview generator 1925, based on information from the editing module 1920 (and, in some embodiments, other modules), sends information about how to display each pixel of a video or image to the display module 1965.

While many of the features have been described as being performed by one module (e.g., the navigation module 1915 or frame compressor 1935), one of ordinary skill would recognize that the functions might be split up into multiple modules, and the performance of one feature might even require multiple modules.

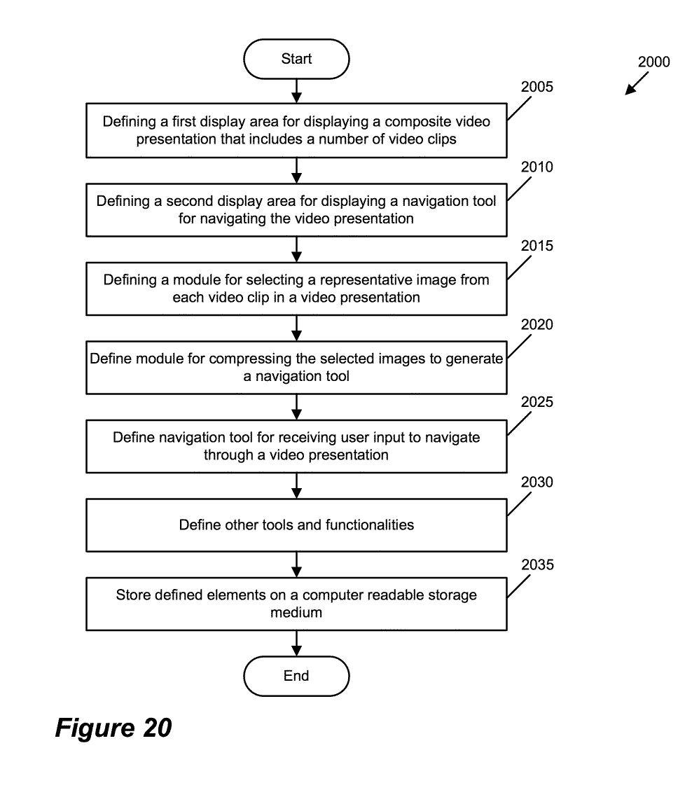

FIG. 20 conceptually illustrates a process 2000 of some embodiments for manufacturing a computer readable medium that stores a computer program. In some embodiments, the computer readable medium is a distributable CD-ROM. As shown, the process begins by defining (at 2005) a first display area for displaying a composite video presentation that includes a number of video clips. Display area 1405 of FIG. 14 is one example of such a display area.

Process 2000 then defines (at 2010) a second display area for displaying a navigation tool for navigating the video presentation. The process then defines (at 2015) a module for selecting a representative image from each video clip in a video presentation, such as video picture selector 1930. The process also defines (at 2020) a module for compressing the selected images to generate a navigation tool, such as video picture compressor 1935. Next, the process defines (at 2025) a navigation tool for receiving user input to navigate through a video presentation. One example of such a navigation tool is navigation tool 1430 of FIG. 14. Process 2000 then defines (at 2030) other tools and functionalities. In some embodiments, these include color correction tools such as 1415 and 1420, although many other items may be defined as well. In some embodiments, these tools and functionalities include media player tools such as tools 1715 and their associated functionalities.

The process next stores (at 2035) the defined elements (i.e., the defined modules, UI items, etc.) on a computer readable storage medium. As mentioned above, in some embodiments the computer readable storage medium is a distributable CD-ROM. In some embodiments, the medium is one or more of a solid-state device, a hard disk, a CD-ROM, or other non-volatile computer readable storage medium. One of ordinary skill in the art will recognize that the various modules and UI items defined by process 2000 are not exhaustive of the modules and UI items that could be defined and stored on a computer readable storage medium for an editing application incorporating some embodiments of the invention.

One of ordinary skill in the art will recognize that the various modules and UI items defined by process 2000 are not exhaustive of the modules and UI items that could be defined and stored on a computer readable storage medium for an editing application incorporating some embodiments of the invention.

### VI. Computer System

Many of the above-described features and applications are implemented as software processes that are specified as a set of instructions recorded on a computer readable storage medium (also referred to as computer readable medium). When these instructions are executed by one or more computational element(s) (such as processors or other computational elements like ASICs and FPGAs), they cause the computational element(s) to perform the actions indicated in the instructions. Computer is meant in its broadest sense, and can include any electronic device with a processor. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs when installed to operate on one or more computer systems define one or more specific machine implementations that execute and perform the operations of the software programs.

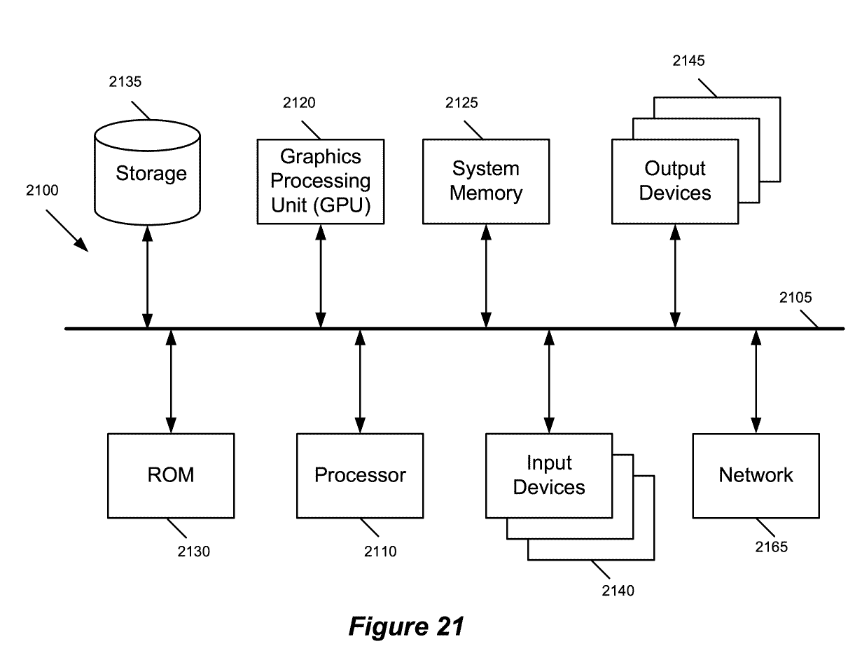

FIG. 21 illustrates a computer system with which some embodiments of the invention are implemented. Such a computer system includes various types of computer readable media and interfaces for various other types of computer readable media. Computer system 2100 includes a bus 2105, a processor 2110, a graphics processing unit (GPU) 2120, a system memory 2125, a read-only memory 2130, a permanent storage device 2135, input devices 2140, and output devices 2145.

The bus 2105 collectively represents all system, peripheral, and chipset buses that communicatively connect the numerous internal devices of the computer system 2100. For instance, the bus 2105 communicatively connects the processor 2110 with the read-only memory 2130, the GPU 2120, the system memory 2125, and the permanent storage device 2135.

From these various memory units, the processor 2110 retrieves instructions to execute and data to process in order to execute the processes of the invention. In some embodiments, the processor comprises a Field Programmable Gate Array (FPGA), an ASIC, or various other electronic components for executing instructions. In some embodiments, the processor Some instructions are passed to and executed by the GPU 2120. The GPU 2120 can offload various computations or complement the image processing provided by the processor 2110. In some embodiments, such functionality can be provided using CoreImage's kernel shading language.

The read-only-memory (ROM) 2130 stores static data and instructions that are needed by the processor 2110 and other modules of the computer system. The permanent storage device 2135, on the other hand, is a read-and-write memory device. This device is a non-volatile memory unit that stores instructions and data even when the computer system 2100 is off. Some embodiments of the invention use a mass-storage device (such as a magnetic or optical disk and its corresponding disk drive) as the permanent storage device 2135.

Other embodiments use a removable storage device (such as a floppy disk, flash drive, or ZIP® disk, and its corresponding disk drive) as the permanent storage device. Like the permanent storage device 2135, the system memory 2125 is a read-and-write memory device. However, unlike storage device 2135, the system memory is a volatile read-and-write memory, such a random access memory. The system memory stores some of the instructions and data that the processor needs at runtime. In some embodiments, the invention's processes are stored in the system memory 2125, the permanent storage device 2135, and/or the read-only memory 2130. For example, the various memory units include instructions for processing multimedia items in accordance with some embodiments. From these various memory units, the processor 2110 retrieves instructions to execute and data to process in order to execute the processes of some embodiments.

The bus 2105 also connects to the input and output devices 2140 and 2145. The input devices enable the user to communicate information and select commands to the computer system. The input devices 2140 include alphanumeric keyboards and pointing devices (also called “cursor control devices”). The output devices 2145 display images generated by the computer system. For instance, these devices display a GUI. The output devices include printers and display devices, such as cathode ray tubes (CRT) or liquid crystal displays (LCD).

Finally, as shown in FIG. 21, bus 2105 also couples computer 2100 to a network 2165 through a network adapter (not shown). In this manner, the computer can be a part of a network of computers (such as a local area network (“LAN”), a wide area network (“WAN”), or an Intranet, or a network of networks, such as the internet. For example, the computer 2100 may be coupled to a web server (network 2165) so that a web browser executing on the computer 2100 can interact with the web server as a user interacts with a GUI that operates in the web browser.

Any or all components of computer system 2100 may be used in conjunction with the invention. For instance, in some embodiments the execution of the frames of the rendering is performed by the GPU 2120 instead of the CPU 2110. Similarly, other image editing functions can be offloaded to the GPU 2120 where they are executed before the results are passed back into memory or the processor 2110. However, a common limitation of the GPU 2120 is the number of instructions that the GPU 2120 is able to store and process at any given time. Therefore, some embodiments adapt instructions for implementing processes so that these processes fit onto the instruction buffer of the GPU 2120 for execution locally on the GPU 2120. Additionally, some GPUs 2120 do not contain sufficient processing resources to execute the processes of some embodiments and therefore the CPU 2110 executes the instructions. One of ordinary skill in the art would appreciate that any other system configuration may also be used in conjunction with the present invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable blu-ray discs, ultra density optical discs, any other optical or magnetic media, and floppy disks. The computer-readable media may store a computer program that is executable by at least one processor and includes sets of instructions for performing various operations. Examples of hardware devices configured to store and execute sets of instructions include, but are not limited to application specific integrated circuits (ASICs), field programmable gate arrays (FPGA), programmable logic devices (PLDs), ROM, and RAM devices. Examples of computer programs or computer code include machine code, such as produced by a compiler, and files including higher-level code that are executed by a computer, an electronic component, or a microprocessor using an interpreter.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

I claim:

1. A method comprising:
providing a first display area for displaying a video presentation, the video presentation comprising a plurality of video clips, each video clip comprising a particular sequence of consecutive video pictures;
providing a navigation tool for navigating the video presentation, the navigation tool comprising a display of a representative video picture from each video clip in the video presentation, the entire navigation tool for display at one time in a second display area.

2. The method of claim 1, wherein the representative video picture for a particular video clip is the first video picture in the video clip.

3. The method of claim 1, wherein the representative video picture for a particular video clip is a particular number of video pictures from the start of the particular video clip.

4. The method of claim 1, wherein the representative video picture for a particular video clip is selected based on a color analysis of the particular video clip.

5. The method of claim 1 further comprising providing a third display area for displaying thumbnail images representing a subset of the video clips in the video presentation.

6. The method of claim 5, wherein the thumbnail images are for a user to scroll though by using the navigation tool.

7. The method of claim 6 further comprising providing a window for moving along the navigation tool in order to scroll though the thumbnail images.

8. The method of claim 1, wherein the particular sequence of video pictures for a particular video clip is based on edit points defined by a user in a video-editing application.

9. The method of claim 1, wherein a particular representative video picture in the navigation tool is selectable to cause the particular video clip corresponding to the particular representative video picture to be displayed in the first display area.

10. The method of claim 9, wherein the first display area is an editing window.

11. The method of claim 10 further comprising providing a set of editing tools for editing the particular video clip displayed in the editing window.

12. The method of claim 11, wherein the set of editing tools comprises color correction tools.

13. A computer readable medium storing a computer program which when executed by at least one processor presents a video presentation to a user, the computer program comprising sets of instructions for:
receiving a video presentation to display, the video presentation comprising a plurality of video clips, each video clip comprising a particular sequence of video pictures that are consecutively ordered in the video project;
for each video clip, selecting a representative video picture; and
displaying a tool for navigating through the video presentation, the tool comprising a concurrent display of all of the selected representative video pictures.

14. The computer readable medium of claim 13, wherein the sets of instructions are performed by a video-editing application.

15. The computer readable medium of claim 13, wherein the set of instructions for displaying the tool for navigating the video presentation comprises sets of instructions for:
determining a total area for displaying the representative video pictures;
determining a size for each of the representative video pictures, wherein the size is equal for each video pictures and all of the representative video pictures are displayed at once; and
displaying the video pictures from left to right in an order based on the order of the video clips in the video project.

16. The computer readable medium of claim 13, wherein the computer program further comprises sets of instructions for:
receiving a user selection of one of the video clips; and
displaying a video picture from the user selected video clip in an editing window.

17. The computer readable medium of claim 16, wherein the computer program further comprises editing the video clip based on user interactions with video editing tools.

18. A computer readable storage medium storing a computer program for execution by at least one processor, the computer program comprising a graphical user interface (GUI), the GUI comprising:
a first display area for displaying a video presentation, the video presentation comprising a plurality of video clips, each video clip comprising a particular sequence of consecutive video pictures;
a navigation tool for navigating the video presentation, the navigation tool comprising a display of a representative video picture from each video clip in the video presentation, the entire navigation tool for display at one time in a second display area.

19. The computer readable storage medium of claim 18, wherein the GUI further comprises a user-movable scroll window over the navigation tool for receiving user input to move along the navigation tool.

20. The computer readable storage medium of claim 19, wherein the GUI further comprises a third display area for displaying set of scrollable thumbnail images representing the video clips in the video presentation, wherein user input to move the scroll window along the navigation tool causes the thumbnail images to scroll through the third display area.

21. The computer readable storage medium of claim 20, wherein the scrollable thumbnail images are user-selectable UI items, wherein a user selection of a particular thumbnail image causes a particular video clip represented by the particular thumbnail image to be displayed in the first display area.
